(19) United States
(12) Patent Application Publication
(10) Pub. No.: US 2006/0103452 A1
(43) Pub. Date: May 18, 2006

(54) Internal voltage generator for semiconductor device

(76) Inventors: Sang Jin Byeon, Kyoungki-do (KR); Kee Teok Park, Kyoungki-do (KR)

Correspondence Address: LADAS & PARRY LLP, 224 SOUTH MICHIGAN AVENUE, SUITE 1600, CHICAGO, IL, 60604, US

(21) Appl. No.: 11/121,620

(22) Filed: May 4, 2005

(30) Foreign Application Priority Data
Nov. 15, 2004 (KR) 10-2004-0093118

(51) Int. Cl. G05F 1/10

(52) U.S. Cl. 327/541

(57) ABSTRACT

Disclosed is an internal voltage generator capable of outputting a constant voltage regardless of change of a supply voltage. The internal voltage generator includes a current mirror unit, drivers and a voltage divider and prevents a channel length modulation phenomenon by changing the structure of the current mirror unit.

### BACKGROUND OF THE INVENTION

1. Field of the Invention

The present invention relates to an internal voltage generator used in a semiconductor device, and more particularly to an internal voltage generator capable of outputting a constant voltage regardless of change of a supply voltage.

2. Description of the Prior Art

Generally, a semiconductor device such as a memory device converts a supply voltage VDD to an internal voltage Vint smaller than the supply voltage VDD according to the requirement of an ultra high speed and a low power, and uses the internal voltage Vint. For this, the semiconductor device includes a plurality of internal voltage generators having various functions.

FIG. 1 is a circuit diagram showing one example of a conventional internal voltage generator.

Before a description about the operation of the internal voltage generator shown in FIG. 1 is given, signals used in FIG. 1 will be first described.

In FIG. 1, a signal “act” is an active mode signal enabled when a semiconductor device enters an active mode requiring large power consumption, a signal “test” is a test signal, and a signal “power up” is a power up signal representing whether supply voltages “VDD and VSS” applied to a circuit has arrived at a stable level. Further, a reference voltage “VREF” is a reference voltage generated in an external or an internal of the semiconductor device. Further, a voltage “Vinternal” represents an internal voltage applied to an internal circuit of the semiconductor device operating in the active mode. Further, a voltage “Vint REF” is an output signal of a voltage divider (circuit connected between an internal voltage “Vinternal” output node and a ground) and has a voltage corresponding to about the half of the internal voltage “Vinternal”.

In FIG. 1, the P1 to p9 represent PMOS transistors and the N1 to N7 represent NMOS transistors.

The internal voltage generator of FIG. 1 normally operates when the signals “act” and “test” are at a high level and the power up signal is at a high level.

In the operation of the internal voltage generator, when the reference voltage “VREF” is larger than the voltage “Vint REF”, electric current flowing to the transistor N2 increases as compared with electric current flowing to the transistor N4. Therefore, the voltage of a node “a” is lower than that of a node “c”. Accordingly, a gate voltage of the transistor N5 gradually increases, so that the voltage of a node “d” is dropped down. Consequently, electric current flowing in the transistor P8 increases, so that the internal voltage “Vinternal” gradually increases. This process continues until the voltage “Vint REF” is equal to the reference voltage “VREF”.

However, even after the internal voltage “Vinternal”, which is described in FIG. 1 and generated according to the prior art, becomes twice as large as the reference voltage “VREF”, the internal voltage “Vinternal” increases with a positive slope when the supply voltage VDD increases.

This is caused by the characteristics of a transistor occurring according to the reduction of a design rule. In particular, this phenomenon is related to a channel length modulation.

A channel length modulation is a phenomenon occurring when the gate length of a transistor is reduced according to the reduction of a design rule. That is, the channel length modulation represents a phenomenon in which an effective channel length is reduced in a region (vds≧vgs−vt), which is a saturation region, by the influence of electric field formed by a bias voltage applied to the source and the drain of the transistor, and thus electric current I_{dS} increases. Herein, the vds represents a voltage difference between the drain and the source, the vgs represents a voltage difference between the gate and the source, and the vt represents a threshold voltage.

By this reason, when the supply voltage VDD increases even after the internal voltage “Vinternal” becomes twice as large as the reference voltage “VREF”, the voltage vds of the transistor P1 increases even though the node “a” sufficiently maintains a high level. Therefore, electric current flowing in the transistor P1 gradually increases. As a result, the gate voltage of the transistor N5 increases and the voltage of the node “d” is dropped down. Consequently, the internal voltage “Vinternal” increases.

As described above, the channel length modulation phenomenon occurs in the transistor due to the reduction of the design rule. Therefore, when the supply voltage changes, the internal voltage changes, which must remain at a stable voltage.

Further, the changes of the internal voltage may reduce the operation reliability of the semiconductor device and thus cause an abnormal operation of the semiconductor device.

### SUMMARY OF THE INVENTION

Accordingly, the present invention has been made to solve the above-mentioned problems occurring in the prior art, and an object of the present invention is to provide an internal voltage generator capable of outputting a stable internal voltage even when an external supply voltage changes.

For this, the present invention provides a method capable of fundamentally preventing a channel length modulation phenomenon of a transistor by blocking electric current flowing in a transistor P6 when an internal voltage reaches a target level through the structure change of a current mirror unit.

In order to achieve the above objects, according to one aspect of the present invention, there is provided an internal voltage generator for a semiconductor device, the internal voltage generator comprising: a current mirror unit including a first transistor, a second transistor, a third transistor, a fourth transistor and a fifth transistor, the first transistor being connected between a supply voltage and a first node, the second transistor being connected between the first node and a second node, the third transistor being connected between the supply voltage and a third node, the fourth transistor being connected between the third node and the second node, the fifth transistor being connected between the second node and a ground, gates of the first and the third transistor being commonly connected to the first node; a first driver controlled by output signals outputted from the first node and the third node of the current mirror unit; a second driver controlled by an output signal of the first driver; and a voltage divider connected between an output node of the second driver and the ground, wherein a reference voltage is applied to a gate of the second transistor, wherein an output signal of the voltage divider is applied to a gate of the fourth transistor, wherein an internal voltage is outputted from the output node of the second driver.

In the present invention, the second driver is turned on and the supply voltage is supplied to the output node of the second driver when the reference voltage is larger than the output signal of the voltage divider, and the second driver is turned off and the supply voltage is not supplied to the output node of the second driver when the output signal of the voltage divider is larger than the reference voltage.

### BRIEF DESCRIPTION OF THE DRAWINGS

The above and other objects, features and advantages of the present invention will be more apparent from the following detailed description taken in conjunction with the accompanying drawings, in which:

FIG. 1 is a circuit diagram showing one example of a conventional internal voltage generator;

FIG. 2 is a circuit diagram showing an internal voltage generator according to an embodiment of the present invention; and

FIGS. 3 to 5 are graphs for comparing performance of the prior art with that of the present invention.

### DETAILED DESCRIPTION OF THE PREFERRED EMBODIMENTS

Hereinafter, a preferred embodiment of the present invention will be described with reference to the accompanying drawings.

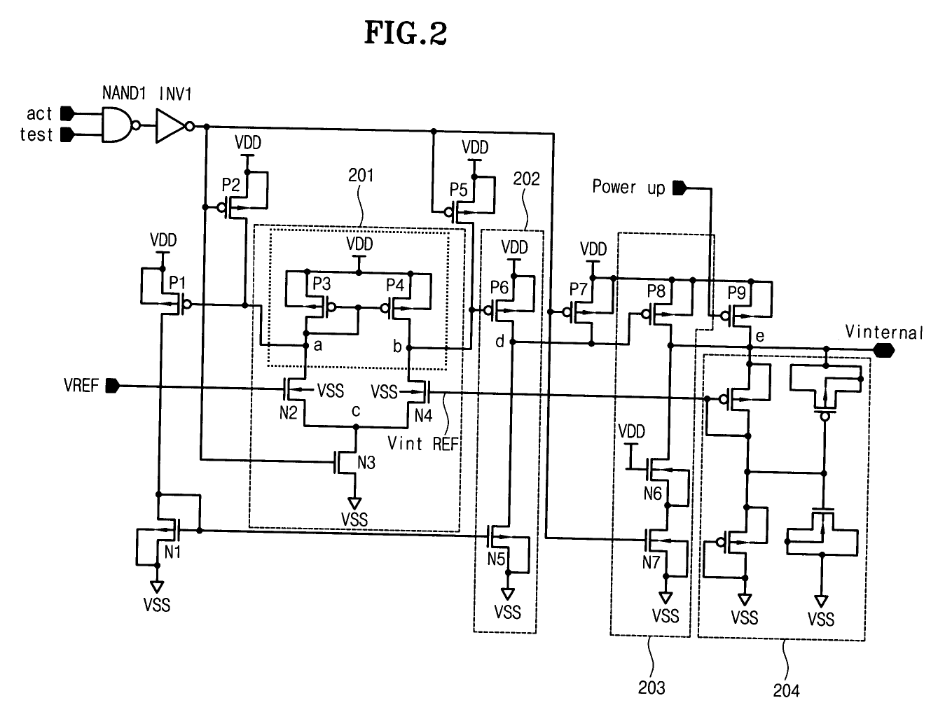

FIG. 2 is a circuit diagram showing an internal voltage generator for a semiconductor device according to an embodiment of the present invention.

As shown in FIG. 2, the internal voltage generator for the semiconductor device includes a signal processing circuit (circuit excepting for an internal voltage circuit) for processing signals used in an initial operation, and operation circuits 201 to 204 allowing an embodiment of the present invention. Herein, it should be noted that the technical idea of the present invention lie in the operation circuits in spite of the differentiation between the signal processing circuit the operation circuits in the following description.

Before a description for the construction and operation of the circuit of FIG. 2 is given, signals used in FIG. 2 will be first described.

In FIG. 2, a signal “act” is an active mode signal enabled when a semiconductor device enters an active mode requiring large power consumption, a signal “test” is a test signal, and a signal “power up” is a power up signal representing whether supply voltages “VDD and VSS” applied to a circuit has arrived at a stable level. Further, a reference voltage “VREF” is a reference voltage generated in an external or an internal of the semiconductor device. Further, a voltage “Vinternal” represents an internal voltage applied to an internal circuit of the semiconductor device operating in the active mode. Further, a voltage “Vint REF” is an output signal of a voltage divider 204 and represents a feedback voltage having a voltage corresponding to about the half of the internal voltage “Vinternal”.

As shown in FIG. 2, the internal voltage generator for the semiconductor device includes an NAND gate NAND1 for receiving the signals “act and test”, an inverter INV1 for receiving an output signal of the NAND gate NAND1, PMOS transistors P2, P5 and P7 and NMOS transistors N3 and N7 controlled by an output signal of the inverter INV1, an operation adjuster P1 and N1, a current mirror unit 201, a first driver 202 controlled by output signals outputted from the node “a” and the node “b” of the current mirror unit 201, a second driver 203 controlled by an output signal of the first driver 202, and a voltage divider 204 for reducing the internal voltage “Vinternal”, which is an output voltage of the second driver 203, by half, and outputting the reduced internal voltage “Vinternal”.

The current mirror unit 201 includes a transistor P3 connected between the supply voltage “VDD” and the node “a”, a transistor N2 connected between the node “a” and a node “c”, a transistor P4 connected between the supply voltage “VDD” and the node “b”, a transistor N4 connected between the node “b” and the node “c”, and a transistor N3 connected between the node “c” and the ground VSS. The common gates of the transistors P3 and P4 of the current mirror unit 201 are connected to the node “a”. Further, the reference voltage “VREF” is applied to the gate of the transistor N2 and the output voltage “Vint REF” of the voltage divider is applied to the gate of the transistor N4.

The output node of the inverter INV1 is connected to the gate of the transistor P2 and the transistor P2 is connected between the supply voltage “VDD” and the node “a”. Further, the output node of the inverter INV1 is connected to the gate of the transistor P5 and the transistor P5 is connected between the supply voltage “VDD” and the node “b”.

The operation adjuster P1 and N1 include transistors P1 and N1 connected in series between the supply voltage “VDD” and the ground. As shown in FIG. 2, the gate node and the drain node of the transistor N1 are connected to each other.

The voltage of the node “a” of the current mirror unit 201 is applied to the gate of the transistor P1 of the operation adjuster P1 and N1.

The first driver 202 includes transistors P6 and N5 connected in series between the supply voltage “VDD” and the ground. The gate of the transistor P6 is connected to the node “b” of the current mirror unit 201 and the gate of the transistor N5 is connected to the gate of the transistor N1.

A transistor P7 is located between the supply voltage “VDD” and the output node “d” of the first driver 202 and the gate of the transistor P7 is connected to the output node of the inverter INV1.

The second driver 203 includes transistors P8, N6 and N7 connected in series between the supply voltage “VDD” and the ground. The node “d” is connected to the gate of the transistor P8, the gate of the transistor N6 is connected to the supply voltage “VDD”, and the gate of the transistor N7 is connected to the output node of the inverter INV1.

A transistor P9 is located between the supply voltage “VDD” and the output node “e” of the second driver 203, and the power up signal is applied to the gate of the transistor P9. A voltage outputted from the node “e” is the internal voltage “Vinternal”.

The voltage divider 204 is located between the node “e” and the ground and outputs the voltage “Vint REF” corresponding to the half of the internal voltage “Vinternal”. The circuit of the voltage divider 204 can be variously constructed. The output signal “Vint REF” of the voltage divider 204 is applied to the gate of the transistor N4 of the current mirror unit 201.

Hereinafter, the operation of the internal voltage generator shown in FIG. 2 will be described.

First, the power up signal maintains a low level before the supply voltage “VDD” reaches a predetermined level. In such a case, the internal voltage “Vinternal” follows the level of the supply voltage “VDD”.

Next, after the supply voltage “VDD” reaches the predetermined level, the power up signal shifts to a high level. In such a case, the transistor P9 is turned off and the output level of the internal voltage “Vinternal” is determined by the logical levels of the signals “act and test”.

Hereinafter, a case in which the supply voltage “VDD” exceeds the predetermined level, that is, an operation after the supply voltage “VDD” reaches a stable level, will be described.

First, a case in which the semiconductor device is not in an active mode, that is, the semiconductor device is in a waiting mode, will be described. When the semiconductor device is in the waiting mode, the signal “act” is at a low level (i.e. in a disable state). Accordingly, the output of the inverter INV1 is at a low level. Since the output of the inverter INV1 is at a low level, the current mirror unit 201 is in a disable state and the transistor P8 is turned on. Therefore, the supply voltage “VDD” is transferred to the node “e” through the transistor P8. Consequently, the internal voltage “Vinternal” of the semiconductor device has the same voltage level as that of the supply voltage “VDD”.

Next, a case in which the semiconductor device is in the active mode will be described. When the semiconductor device is in the active mode, the signal “act” is enabled to be at a high level. Further, the operation of the internal voltage generator is determined according to the logical level of the test signal.

Herein, a case in which the semiconductor device is in the active mode and the test signal is enabled to be at a low level will be described. The fact that the test signal is at the low level represents a case in which the semiconductor device is in a test mode. In such a case, since the output voltage of the inverter INV1 is at a low level, the internal voltage generator has the same operation as that in a case in which the semiconductor device is in the waiting mode.

Then, a case in which the semiconductor device is in the active mode and the test signal is enabled to be at a high level will be described. The fact that the test signal is at the high level represents a case in which the semiconductor device is not in the test mode. In such a case, the output voltage of the inverter INV1 is at a high level. Therefore, the transistors N3 and N7 are turned on and the transistors P2, P5 and P7 are turned off. Consequently, the current mirror unit 201, the first driver 202, and the second driver 203, and the voltage divider 204 normally operate.

When the internal voltage generator normally operates, the change process of the internal voltage “Vinternal” will be described according to size of the reference voltage “VREF” and the output signal “Vint REF” of the voltage divider 204. Herein, the reference voltage “VREF” must be setup before the power up signal is shifted to be at a high level.

For the general understanding regarding the operation of the circuit, the operation of the current mirror unit 201 will first be described.

The power up signal for detecting whether the circuit has been initialized is enabled to be at a high level, the signal “act” at a high level, which represents that the semiconductor device is in an active mode, is applied to the internal voltage generator. Further, when the semiconductor device is not in a test mode, that is, the test signal is disabled to be at a high level, the output voltage of the inverter INV1 is at a high level. Accordingly, the transistors P2, P5 and P7 are turned off and the transistors N3 and N7 are turned on, so that the current mirror unit 201 operates.

First, a case in which the reference voltage “VREF” is lower than the output voltage “Vint REF” of the voltage divider 204 will be described.

In such a case, the voltage of the node “b” is shifted to a low level so as to turn on the transistor P6. When the transistor P6 is turned on, the potential of the node “b” rises to the supply voltage “VDD” level. Accordingly, the full-up transistor P8 of the second driver 203 is turned off. Consequently, the internal voltage “Vinternal” maintains the previous voltage. However, the internal voltage “Vinternal” is dropped down little by little according to the passage of time. This is resulted from power consumption due to continuous active operation.

Next, a case in which the reference voltage “VREF” is larger than the output voltage “Vint REF” of the voltage divider 204 will be described.

In such a case, the voltage of the node “c” is shifted to a low level so as to turn on the transistor P1. Simultaneously, the transistors P3 and P4 are turned on. Accordingly, the node “b” is shifted to a high level so as to turn off the transistor P6.

When the transistor P1 is turned on, the transistor N5 is turned on. Therefore, the node “d” has a potential of a low level. Accordingly, the transistor P8 is turned on and the supply voltage is supplied to the node “e”. Consequently, the potential level of the internal voltage “Vinternal” increases.

The voltage divider 204 outputs a voltage corresponding to the half of the internal voltage “Vinternal”. Accordingly, when the internal voltage increases, the output voltage “Vint REF” of the voltage divider 204 applied to the gate of the transistor N4 also increases.

Finally, the aforementioned process is continued until the internal voltage “Vinternal” is twice as large as the reference voltage “VREF”. In particular, when the internal voltage “Vinternal” is reduced due to the increase of power consumption according to the continuous performance of operation in the active mode, a feedback operation for increasing the internal voltage is repeated.

As compared with the prior art, the operation characteristic of the present invention as described above is as follows.

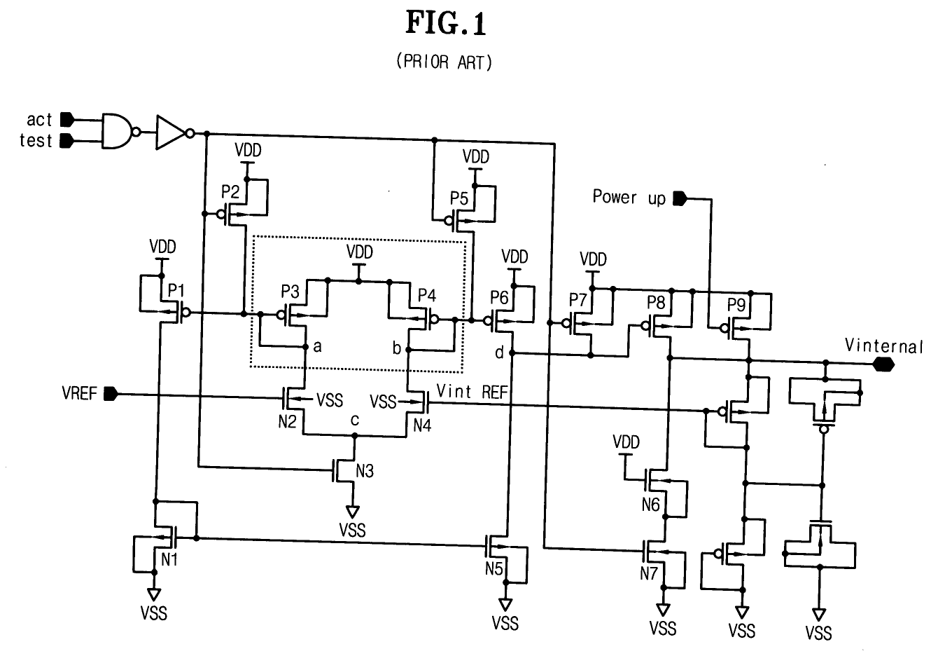

As shown in a comparison with FIG. 1, the load transistors P3 and P4 of the current mirror unit 201 of the present invention shown in FIG. 2 have a structure different from that of the prior art.

The difference between the present invention and the prior art is as follows.

For example, a case in which the reference voltage “VREF” is larger than the voltage “Vint REF” will be described.

In the prior art shown in FIG. 1, the potential of the node “a” relatively decreases and the potential of the node “b” relatively increases. Since the potential of the node “a” decreases, the transistor P1 is turned on. Therefore, electric current flowing in the transistor N5 gradually increases. Consequently, the potential of the node “d” decreases. However, even though the potential of the node “b” is relatively larger than that of the node “a”, when the voltage vds of the transistor P6 increases according to the increase of the supply voltage, electric current flowing in the transistor P6 also increases due to the channel length modulation phenomenon. Accordingly, the potential of the node “d” does not sufficiently maintain a low voltage. Therefore, there may be a problem in allowing the internal voltage to reach a desired voltage level within a short time.

In contrast, in the present invention, as shown in FIG. 2, when the potential of the node “a” decreases, the gate potential of the transistor P4 also decreases. Therefore, the voltage of the node “b” rapidly increases and the turn-off speed of the transistor P6 increases. As a result, the voltage down speed at the node “d” is faster than the speed in the case of FIG. 1.

That is, in FIG. 1, since the transistor P6 is not completely turned off, the supply voltage is supplied to the node “d” through the transistor P6. Therefore, a full-down effect of the node “d” due to the transistor N5 is slow.

In contrast, in the present invention shown in FIG. 2, the transistor P6 is completely turned off, so that the full-down effect of the node “d” due to the transistor N5 is improved.

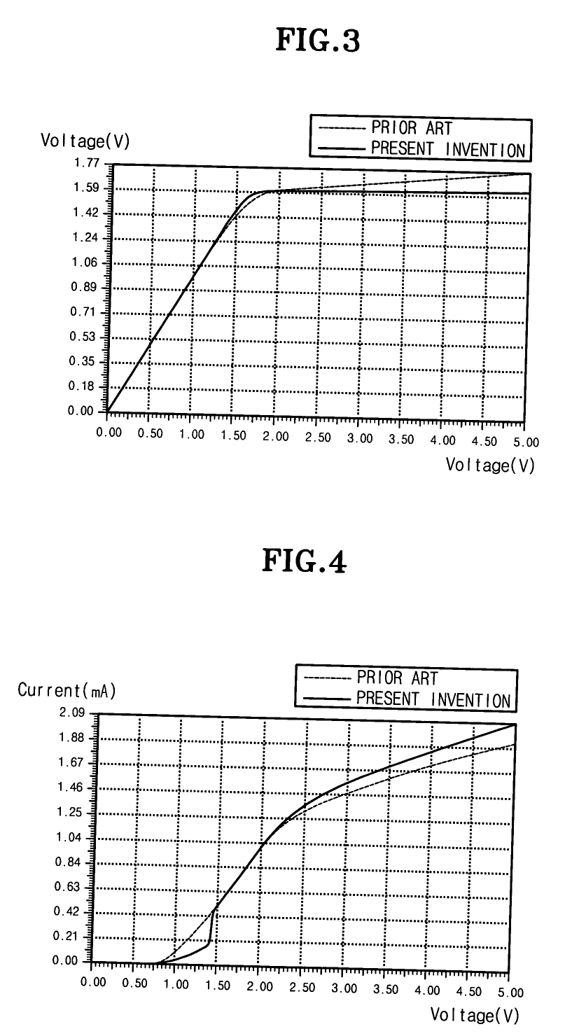

FIGS. 3 to 5 show a simulation result for a slope characteristic representing a technical difference between the prior art and the present invention.

In FIG. 3, the dotted line indicates the prior art and the solid line indicates the present invention. As shown in FIG. 3, when the supply voltage “VDD” is larger than 1.75V, the internal voltage in the prior art gradually increases. However, in the present invention, the internal voltage is stable at a constant level.

FIG. 4 shows a comparison of power consumption amount between the prior art and the present invention.

As shown in FIG. 4, one can see that the power consumption amount in the prior art is nearly equal to that in the present invention in an operation range (supply voltage is 1.5V˜2.5V).

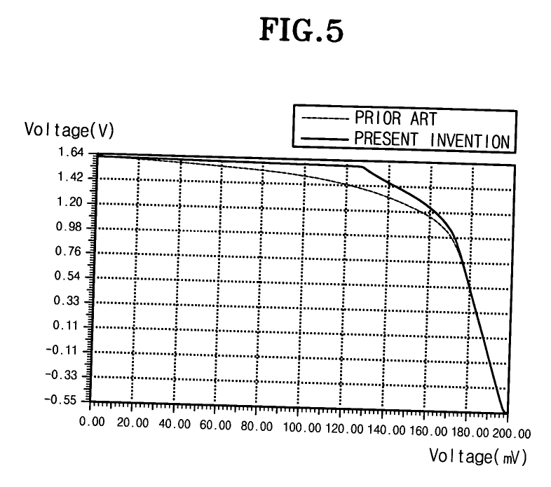

FIG. 5 shows a comparison of operating ability between the prior art and the present invention.

As shown in FIG. 5, one can see that the operating ability of the internal voltage according to the present invention is superior to that in the prior art in a range in which the supply voltage “VDD” is 80 mV˜170 mV.

As described above, as compared with the prior art, the present invention has the power consumption amount similar to that in the prior art. However, the present invention outputs a stable internal voltage and has superior operating ability.

According to the present invention as described above, an internal voltage generator can solve a slope problem of an internal voltage “Vinternal” according to the change of a supply voltage “VDD”. Therefore, the operation reliability of a semiconductor device can be improved.

The preferred embodiment of the present invention has been described for illustrative purposes, and those skilled in the art will appreciate that various modifications, additions and substitutions are possible, without departing from the scope and spirit of the invention as disclosed in the accompanying claims.

What is claimed is:

1. An internal voltage generator for a semiconductor device, the internal voltage generator comprising:
a current mirror unit including a first transistor, a second transistor, a third transistor, a fourth transistor and a fifth transistor, the first transistor being connected between a supply voltage and a first node, the second transistor being connected between the first node and a second node, the third transistor being connected between the supply voltage and a third node, the fourth transistor being connected between the third node and the second node, the fifth transistor being connected between the second node and a ground, gates of the first and the third transistor being commonly connected to the first node;
a first driver controlled by output signals outputted from the first node and the third node of the current mirror unit;
a second driver controlled by an output signal of the first driver; and
a voltage divider connected between an output node of the second driver and the ground,
wherein a reference voltage is applied to a gate of the second transistor,
wherein an output signal of the voltage divider is applied to a gate of the fourth transistor,
wherein an internal voltage is outputted from the output node of the second driver.

2. The internal voltage generator as claimed in claim 1, wherein the second driver is turned on and the supply voltage is supplied to the output node of the second driver when the reference voltage is larger than the output signal of the voltage divider, and the second driver is turned off and the supply voltage is not supplied to the output node of the second driver when the output signal of the voltage divider is larger than the reference voltage.

3. The internal voltage generator as claimed in claim 1, wherein the output signal of the voltage divider has a voltage level corresponding to one-half of a level of the internal voltage outputted from the output node of the second driver.

4. The internal voltage generator as claimed in claim 1, wherein an output signal of the current mirror unit includes a voltage level at the first node and a voltage level at the third node.

5. The internal voltage generator as claimed in claim 4, wherein the first driver includes a first full-up transistor and a first full-down transistor,
the first full-down transistor is turned on when the reference voltage is larger than the output signal of the voltage divider,
the first full-up transistor is turned on when the output signal of the voltage divider is larger than the reference voltage,
the second driver is turned on and the supply voltage is supplied to the output node of the second driver only when the first full-down transistor is turned on.

6. The internal voltage generator as claimed in claim 5, wherein a voltage level of the output signal of the voltage divider is one-half of a level of the internal voltage outputted from the output node of the second driver.
